(19) United States
(12) Patent Application Publication
(10) Pub. No.: US 2026/0253525 A1
(43) Pub. Date: Aug. 27, 2026

(54) DISPLAY DATA PROCESSING METHOD AND APPARATUS, TERMINAL DEVICE, AND STORAGE MEDIUM

(71) Applicants: ZHEJIANG ZEEKR INTELLIGENT TECHNOLOGY CO., LTD., Ningbo (CN); ZHEJIANG GEELY HOLDING GROUP CO., LTD., Hangzhou (CN)

(72) Inventors: Ling ZHU, Ningbo (CN); Chen CHEN, Ningbo (CN); Zhibin ZHANG, Ningbo (CN); Xijie ZHANG, Ningbo (CN)

(73) Assignees: ZHEJIANG ZEEKR INTELLIGENT TECHNOLOGY CO., LTD., Ningbo (CN); ZHEJIANG GEELY HOLDING GROUP CO., LTD., Hangzhou (CN)

(21) Appl. No.: 19/644,157

(22) Filed: Apr. 10, 2026

Related U.S. Application Data
(63) Continuation of application No. PCT/CN2024/140044, filed on Dec. 17, 2024.

(30) Foreign Application Priority Data
Dec. 18, 2023 (CN) 202311743564.X

(51) Int. Cl. G09G 3/20

(52) U.S. Cl. CPC G09G 3/2022; G09G 2320/0626; G09G 2330/021; G09G 2360/16

(57) ABSTRACT

A method for processing display data includes: performing pixel accumulation on a pre-acquired image to be displayed to obtain a calculation result; determining the power level of each frame of the image to be displayed based on the calculation result; writing image information and the power level of each frame of the image into a corresponding data frame; and sending the data frame to a lamp panel so that the lamp panel displays each frame of the image to be displayed based on the power level and the image information.

### CROSS-REFERENCE TO RELATED APPLICATIONS

The present application is a continuation application of International Application No. PCT/CN2024/140044, filed on December 17, 2024, which claims priority to Chinese Patent Application No. 202311743564.X, filed on December 18, 2023. The disclosures of the above-mentioned applications are incorporated herein by reference in their entireties.

### TECHNICAL FIELD

The present application relates to, but are not limited to, the technical field of vehicles, and in particular to a method and an apparatus for processing display data, a terminal device, and a storage medium.

### BACKGROUND

With technological advancements, installing lamp panels on vehicles to display images has become a new decorative and informational means.

Currently, during image display on the lamp panels of the vehicles, the power consumption easily exceeds the maximum permissible power, which shortens the lifespan of the lamp panels.

### SUMMARY

The following is an overview of the subject matter described in detail herein. This overview is not intended to limit the scope of the claims.

The main purpose of the present application is to provide a method and apparatus for processing display data, a terminal device, and a storage medium, aiming to solve the problem that in the current process of displaying images on the lamp panels of the vehicles, the power easily exceeds the maximum permissible power, leading to a shortened lifespan of the lamp panel.

To achieve the above purpose, the present application provides a method for processing display data, applied to a control terminal, including the following steps:

performing pixel accumulation on a pre-acquired image to be displayed to obtain a calculation result;

determining a power level of each frame of the image to be displayed based on the calculation result;

writing image information and the power level of each frame into a corresponding data frame; and

sending the data frame to a lamp panel, so that the lamp panel displays each frame of the image to be displayed based on the power level and the image information.

In an embodiment, the determining the power level of each frame of the image to be displayed based on the calculation result includes:

calculating an initial brightness level of at least one lamp bead in response to that the lamp panel displays each frame of the image;

correcting the at least one lamp bead based on the calculation result and the initial brightness level of the at least one lamp bead to obtain a corrected brightness level; and

determining the power level of each frame of the image based on the corrected brightness level.

In an embodiment, the correcting the at least one lamp bead based on the calculation result and the initial brightness level of the at least one lamp bead to obtain the corrected brightness level includes:

in response to that the calculation result is greater than a first calculation result threshold and less than or equal to a second calculation result threshold, correcting the at least one lamp bead according to the initial brightness level of the at least one lamp bead; and

in response to that the initial brightness level of the at least one lamp bead is greater than or equal to a third brightness level threshold, decreasing the at least one lamp bead by one brightness level to obtain the corrected brightness level.

In an embodiment, the correcting the at least one lamp bead based on the calculation result and the initial brightness level of the at least one lamp bead to obtain the corrected brightness level further includes:

in response to that the calculation result is greater than a second calculation result threshold and less than or equal to a third calculation result threshold, correcting the at least one lamp bead according to the initial brightness level of the at least one lamp bead;

in response to that the initial brightness level of the at least one lamp bead is greater than or equal to a fourth brightness level threshold, decreasing the at least one lamp bead by two brightness levels to obtain the corrected brightness level; or

in response to that the initial brightness level of the at least one lamp bead is greater than or equal to a second brightness level threshold and less than the fourth brightness level threshold, decreasing the at least one lamp bead by one brightness level to obtain the corrected brightness level.

In an embodiment, the correcting the at least one lamp bead based on the calculation result and the initial brightness level of the at least one lamp bead to obtain the corrected brightness level further includes:

in response to that the calculation result is greater than a third calculation result threshold, correcting the at least one lamp bead according to the initial brightness level of the at least one lamp bead;

in response to that the initial brightness level of the at least one lamp bead is greater than or equal to a fifth brightness level threshold, decreasing the at least one lamp bead by three brightness levels to obtain the corrected brightness level;

in response to that the initial brightness level of the at least one lamp bead is greater than or equal to a third brightness level threshold and less than the fifth brightness level threshold, decreasing the at least one lamp bead by two brightness levels to obtain the corrected brightness level; or

in response to that the initial brightness level of the at least one lamp bead is greater than or equal to a first brightness level threshold and less than a third brightness level threshold, decreasing the at least one lamp bead by one brightness level to obtain the corrected brightness level.

In an embodiment, the writing the image information and the power level of each frame into the corresponding data frame includes:

writing a current frame number into first two bytes of the corresponding data frame; and

writing the power level into a third byte of the corresponding data frame.

In an embodiment, the method is applied to a lamp panel, and the method includes the following steps:

receiving a data frame sent by a terminal, the data frame contains image information and a power level written by the terminal, and the power level is determined based on the calculation result obtained by the terminal after performing pixel accumulation on a pre-acquired image to be displayed; and

displaying each frame of the image to be displayed based on the power level.

The embodiment of the present application further proposes an apparatus for processing display data, provided at a control terminal, and the apparatus includes:

a data calculation module configured to perform pixel accumulation on a pre-acquired image to be displayed to obtain a calculation result;

a data preparation module configured to determine a power level of each frame of the image to be displayed based on the calculation result;

a data frame writing module configured to write image information and the power level of each frame of the image into a corresponding data frame; and

an interaction module is configured to send the data frame to a lamp panel, so that the lamp panel displays each frame of the image to be displayed based on the power level and the image information.

The embodiment of the present application further proposes a terminal device, including a memory, a processor, and a program for processing display data stored in the memory and executable on the processor. The program for processing display data, when executed by the processor, implements the method for processing display data as described above.

The embodiment of the present application further proposes a computer-readable storage medium, a program for processing display data is stored on the computer-readable storage medium, and the program for processing display data, when executed by a processor, implements the method for processing display data as described above.

The embodiments of the present application provide a method and an apparatus for processing display data, a terminal device, and a storage medium, the method including: performing the pixel accumulation on the pre-acquired image to be displayed to obtain the calculation result; determining the power level of each frame of the image to be displayed based on the calculation result; writing the image information and the power level of each frame of the image into the corresponding data frame; and sending the data frame to the lamp panel so that the lamp panel displays each frame of the image to be displayed based on the power level and the image information. The embodiment of the present application performs the pixel accumulation on the pre-acquired image to be displayed to obtain the calculation result, determines an appropriate power level based on the calculation result, and sends the power level to the lamp panel through the data frame. This allows the lamp panel to control the display of each frame of the image to be displayed based on the corresponding power level, thereby reducing energy consumption of the lamp panel and extending its lifespan.

Other aspects will become clear after reading and understanding the accompanying drawings and detailed description.

### BRIEF DESCRIPTION OF THE DRAWINGS

FIG. 1 is a functional module diagram of a terminal device to which an apparatus for processing display data belongs according to the present application.

FIG. 2 is a flow chart illustrating a method for processing display data according to an exemplary embodiment of the present application.

FIG. 3 is a flow chart illustrating the method for processing display data according to another exemplary embodiment of the present application.

FIG. 4 is a flow chart illustrating the method for processing display data according to another exemplary embodiment of the present application.

FIG. 5 is a flow chart illustrating the method for processing display data according to another exemplary embodiment of the present application.

FIG. 6 is a flow chart illustrating the method for processing display data according to another exemplary embodiment of the present application.

FIG. 7 is a flow chart illustrating the method for processing display data according to another exemplary embodiment of the present application.

FIG. 8 is a flow chart illustrating the method for processing display data according to another exemplary embodiment of the present application.

The realization of the objectives, functional features, and advantages of the present application will be further explained in conjunction with the embodiments and with reference to the accompanying drawings.

### DETAILED DESCRIPTION OF THE EMBODIMENTS

It should be understood that the specific embodiments described herein are merely illustrative of the present application and are not intended to limit the present application.

The main solution of the embodiments of the present application is: accumulating pixels in a pre-acquired image to be displayed to obtain a calculation result; determining the power level of each frame of the image to be displayed based on the calculation result; writing the image information and power level of each frame into a corresponding data frame; and sending the data frame to the lamp panel, so that the lamp panel can display each frame of the image to be displayed based on the power level and the image information. The embodiments of the present application accumulate pixels in a pre-acquired image to be displayed to obtain the calculation result, then determine an appropriate power level based on the calculation result, and sends the power level to the lamp panel via data frames. This allows the lamp panel to control the display of each frame of the image to be displayed based on the corresponding power level, thereby reducing energy consumption of the lamp panel and extending the lifespan of the lamp panel.

This embodiment of the present application considers that currently, during image display on the lamp panel of the vehicle, the power easily exceeds the maximum allowable power, which shortens the lifespan of the lamp panel.

Therefore, the present application proposes a solution that accumulates pixels in a pre-acquired image to be displayed to obtain a calculation result, then determines an appropriate power level based on the calculation result and sends the power level to the lamp panel via a data frame. This allows the lamp panel to control the display of each frame of the image to be displayed based on the corresponding power level, thereby reducing the energy loss of the lamp panel and extending its service life.

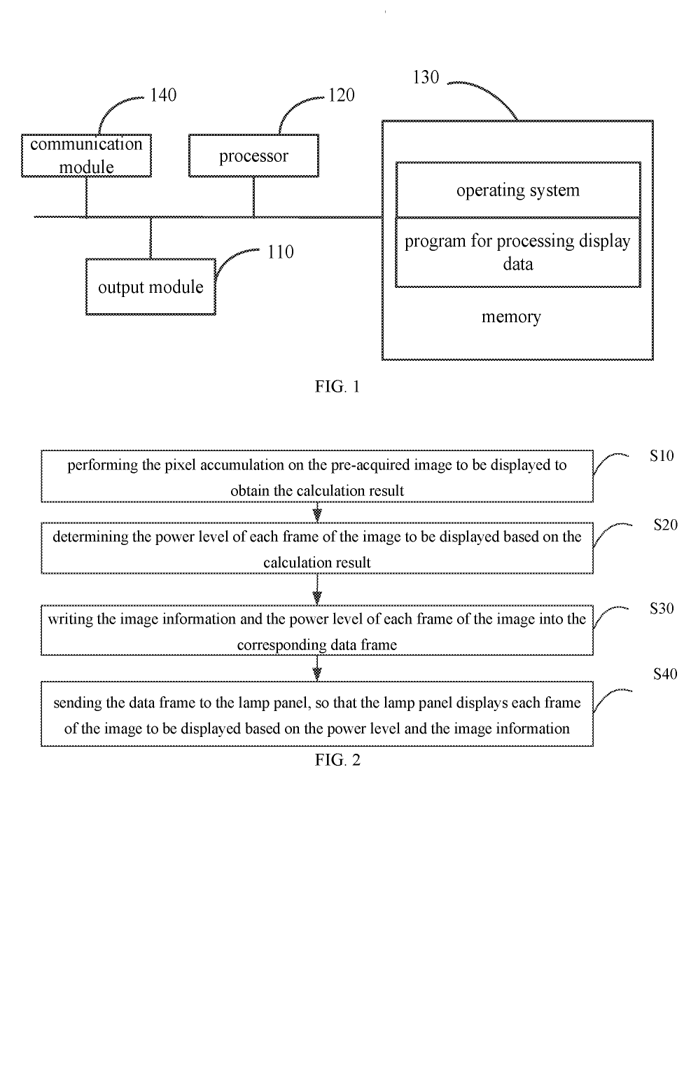

Specifically, referring to FIG. 1, FIG. 1 is a functional module diagram of the terminal device to which the apparatus for processing display data belongs according to the present application. The apparatus for processing display data can be independent of the device and capable of data processing, and can be carried on the device in the form of hardware or software. The device can be a smart mobile terminal with data processing functions, such as a mobile phone or tablet computer, or can be a fixed device or server with data processing functions.

In this embodiment, the terminal device to which the apparatus for processing display data belongs includes at least an output module 110, a processor 120, a memory 130, and a communication module 140.

The memory 130 stores an operating system and a program for processing display data; the output module 110 may be a display screen, etc. The communication module 140 may include a WIFI module and a Bluetooth module, etc., for communication with external devices or servers.

When the program for processing display data in the memory 130, executed by the processor, performs the following steps:

performing pixel accumulation on a pre-acquired image to be displayed to obtain a calculation result;

determining the power level of each frame of the image to be displayed based on the calculation result;

writing the image information and power level of each frame into the corresponding data frame; and

sending the data frame to the lamp panel so that the lamp panel can display each frame of the image to be displayed based on the power level and the image information.

Furthermore, when the program for processing display data in the memory 130 is executed by the processor, the following steps are performed:

calculating an initial brightness level of at least one lamp bead when the lamp panel displays each frame of the image;

correcting the lamp bead based on the calculation result and the initial brightness level of at least one lamp bead to obtain a corrected brightness level; and

determining the power level of each frame of the image based on the corrected brightness level.

Furthermore, when the program for processing display data in the memory 130, executed by the processor, performs the following steps:

correcting the lamp bead according to the initial brightness level of the lamp bead when the calculation result is greater than a first calculation result threshold and less than or equal to a second calculation result threshold; and

if the initial brightness level of the lamp bead is greater than or equal to a third brightness level threshold, decreasing the lamp bead by one brightness level to obtain the corrected brightness level.

Furthermore, when the program for processing display data in the memory 130, executed by the processor, performs the following steps:

correcting the lamp bead according to the initial brightness level of the lamp bead when the calculation result is greater than the second calculation result threshold and less than or equal to the third calculation result threshold; and

if the initial brightness level of the lamp bead is greater than or equal to the fourth brightness level threshold, decreasing the lamp bead by two brightness levels to obtain the corrected brightness level; and

if the initial brightness level of the lamp bead is greater than or equal to the second brightness level threshold and less than the fourth brightness level threshold, decreasing the lamp bead by one brightness level to obtain the corrected brightness level.

Furthermore, when the program for processing display data in the memory 130, executed by the processor, performs the following steps:

when the calculation result is greater than the third calculation result threshold, correcting the lamp bead according to the initial brightness level of the lamp bead;

if the initial brightness level of the lamp bead is greater than or equal to the fifth brightness level threshold, decreasing the lamp bead by three brightness levels to obtain the corrected brightness level; or

if the initial brightness level of the lamp bead is greater than or equal to the third brightness level threshold and less than the fifth brightness level threshold, decreasing the lamp bead by two brightness levels to obtain the corrected brightness level;

if the initial brightness level of the lamp bead is greater than or equal to the first brightness level threshold and less than the third brightness level threshold, decreasing the lamp bead by one brightness level to obtain the corrected brightness level.

Furthermore, when the program for processing display data in the memory 130 is executed by the processor, the following steps are performed:

writing a current frame number into first two bytes of the corresponding data frame; and

writing the power level into a third byte of the corresponding data frame.

Furthermore, when the program for processing display data in the memory 130, executed by the processor, performs the following steps:

receiving a data frame sent by the terminal, the data frame contains the image information and the power level written by the terminal, the power level is determined based on the calculation result obtained by the terminal after performing pixel accumulation on a pre-acquired image to be displayed; and

displaying each frame of the image to be displayed based on the power level.

This embodiment, through the above scheme, specifically performs the pixel accumulation on the pre-acquired image to be displayed to obtain the calculation result; determines the power level of each frame of the image to be displayed based on the calculation result; writes the image information and the power level of each frame into the corresponding data frame; and sends the data frame to the lamp panel so that the lamp panel can display each frame of the image to be displayed based on the power level and the image information. The embodiment of the present application performs the pixel accumulation on the pre-acquired image to be displayed to obtain the calculation result, determines a suitable power level based on the calculation result, and sends the power level to the lamp panel via the data frame. This allows the lamp panel to control the display of each frame of the image to be displayed based on the corresponding power level, thereby reducing energy consumption of the lamp panel and extending the lifespan of the lamp panel.

Based on, but not limited to, the above device architecture, a method embodiment of the present application is proposed.

The execution subject of this method embodiment can be an apparatus for processing display data. The apparatus for processing display data can be independent of the device, capable of data processing, and can be implemented on the device in hardware or software form.

Referring to FIG. 2, FIG. 2 is a flow chart illustrating the method for processing display data according to an exemplary embodiment of the present application. The method is applied to a control terminal, and the method for processing display data includes:

step S10, performing the pixel accumulation on the pre-acquired image to be displayed to obtain the calculation result.

The image to be displayed can be a user-uploaded signature, picture, video, or image drawn in real time by the user.

If the image to be displayed is an animated GIF, a video, or an image drawn in real time by the user, it can be split into several images.

Then, these images are divided based on a preset time unit.

For example, if the image to be displayed is broken down into 30 images, and each preset time unit corresponds to 10 images, the image to be displayed can be divided into 3 groups sequentially based on that time unit.

Then, the pixel data of the images under at least one time unit are accumulated to obtain the calculation result for that group.

For example, based on the three groups of images obtained from the above division, the pixels of the first, second, and third groups can be summed to obtain the calculation result for at least one set of images.

Specifically, each pixel in the image corresponds to a 4-bit grayscale value. The calculation result for that set is obtained by summing the values of each pixel in the image, as shown in the following equation: SubArray_x = sum of (all of 4 bit data) (x ∈ [1, n] represents the nth image in a set of images).

Here, SubArray_x represents the calculation result of the nth image in a set of images.

Then, after obtaining the calculation results for at least one set of images, the calculation results for at least one set of images are filtered, as shown in the following equation: pixel_filter_x = sum of (SubArray_x)/TimeWindow.

Where TimeWindow is a filtering factor.

Then, the maximum value among the calculation results corresponding to at least one set of images after filtering is taken as the calculation result of the image to be displayed, as shown in the following equation: Pixel_max_x = max(at least one set of pixel_filter_x).

Step S20, determining the power level of each frame of the image to be displayed based on the calculation result.

The calculation results can be correlated with the power level, thereby determining the corresponding power level based on the calculation results.

Specifically, in an embodiment, the initial brightness level of at least one lamp bead can be calculated when the lamp panel displays each frame of the image.

Then, based on the calculation result and the initial brightness level of the at least one lamp bead, the lamp bead is corrected to obtain the corrected brightness level.

Finally, the power level of each frame of the image is determined based on the corrected brightness level.

Step S30, writing the image information and the power level of each frame of the image into the corresponding data frame.

The image information may include: image size, current frame number, image type, etc.

For each frame of the image, the image information and the power level of that frame can be written into a preset position within the data frame.

Step S40, sending the data frame to the lamp panel, so that the lamp panel displays each frame of the image to be displayed based on the power level and the image information.

After the control terminal sends the data frame to the lamp panel, the lamp panel reads the power level and the image information from the preset position in the data frame, and then displays the image based on the power level and the image information.

In an embodiment, taking the image to be displayed as the one drawn by the user in real time as an example, when the user draws the image, the image drawn in real time is directly sent to the lamp panel for real-time display, thereby improving the synchronization of image display. Meanwhile, the user-drawn image is used as the image to be displayed, and steps S10 to S40 are executed to calculate the power level of each frame of the image to be displayed and send the power level to the lamp panel. When the lamp panel displays the user-drawn image in real time and then cycles through or re-displays the user-drawn image, the power level determined in step S20 is used to display the image to be displayed. This reduces the energy consumption of the lamp panel and extends the service life of the lamp panel when re-displaying or cycling through the user-drawn image.

This embodiment, through the above solution, performs the pixel accumulation on the pre-acquired image to be displayed to obtain the calculation result; determines the power level of each frame of the image to be displayed based on the calculation result; writes the image information and the power level of each frame into the corresponding data frame; sends the data frame to the lamp panel so that the lamp panel can display each frame of the image to be displayed based on the power level and the image information. This embodiment of the present application performs the pixel accumulation on the pre-acquired image to be displayed to obtain the calculation result, then determines an appropriate power level based on the calculation result, and sends the power level to the lamp panel via the data frame. This allows the lamp panel to control the display of each frame of the image to be displayed based on the corresponding power level, thereby reducing energy consumption of the lamp panel and extending the lifespan of the lamp panel.

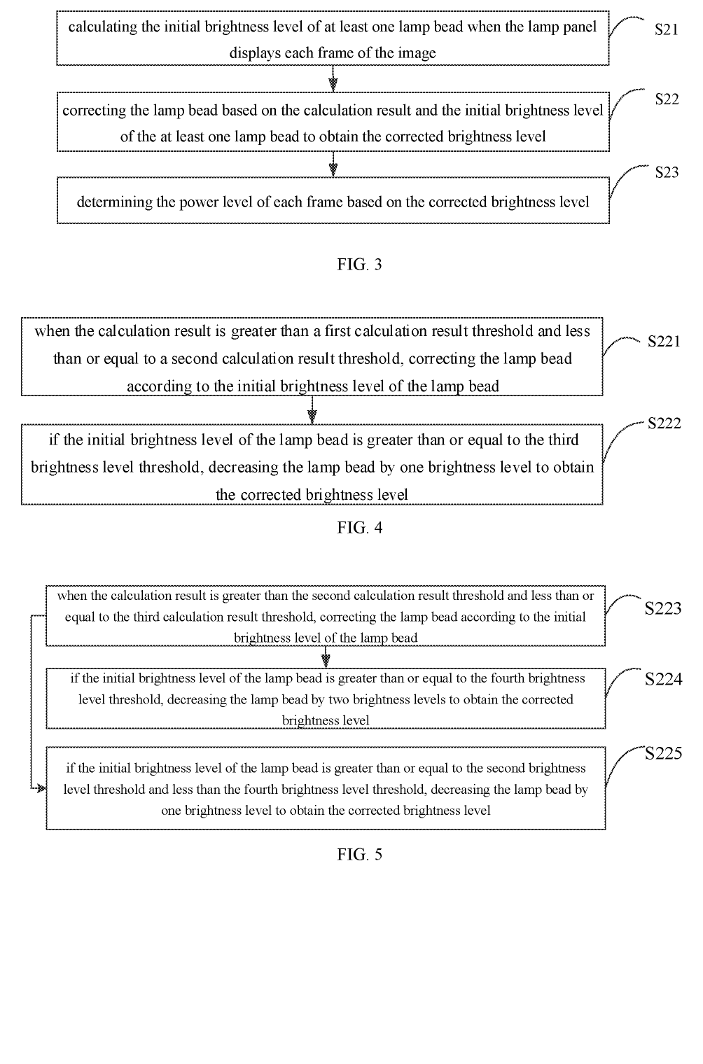

Referring to FIG. 3, FIG. 3 is a flow chart illustrating the method for processing display data according to another exemplary embodiment of the present application.

Based on the embodiment shown in FIG. 2, step S20, determining the power level of each frame of the image to be displayed based on the calculation result, includes the following steps.

Step S21, calculating the initial brightness level of at least one lamp bead when the lamp panel displays each frame of the image.

Each lamp bead has 16 different brightness levels.

The initial brightness level of at least one lamp bead can be calculated based on the displayed content of each frame.

Step S22, correcting the lamp bead based on the calculation result and the initial brightness level of the at least one lamp bead to obtain the corrected brightness level.

The calculation result and the initial brightness level of the at least one lamp bead can be analyzed comprehensively to obtain an analysis result, and the lamp bead is corrected based on this analysis result to obtain the corrected brightness level.

Specifically, in an embodiment, the calculation result and the initial brightness level of at least one lamp bead can be analyzed comprehensively to obtain an analysis result, a correction coefficient is determined based on the analysis result, and this correction coefficient is used to correct the brightness level of the lamp bead.

In another embodiment, different calculation result thresholds can be set based on the calculation results, and different brightness level thresholds can be set based on the brightness level of the lamp bead. The initial brightness level of the lamp bead can be analyzed to determine which calculation result threshold range and which brightness level threshold range it falls into, and the analysis results can be obtained. Based on the analysis results, the lamp bead can be corrected to obtain the corrected brightness level.

Step S23, determining the power level of each frame based on the corrected brightness level.

Different brightness levels of the lamp bead correspond to different power levels.

The power level of the corresponding lamp bead can be retrieved based on the corrected brightness level.

Then, the power levels of all the lamp beads in each frame are calculated. For example, the power levels of all the lamp beads in each frame are summed up, and the sum is used as the power level of that frame image. Alternatively, the power levels of all the lamp beads in each frame are statistically analyzed, and the power level with the highest percentage is used as the power level of that frame, etc.

The embodiment of the present application corrects the lamp bead based on the calculation results and the initial brightness level of at least one lamp bead to obtain a corrected brightness level. Based on the corrected brightness level, the power level of each frame of the image is determined, thereby controlling the power of the image to be displayed, reducing energy loss of the lamp panel, and thus extending the lifespan of the lamp panel.

Referring to FIG. 4, FIG. 4 is a flow chart illustrating the method for processing display data according to another exemplary embodiment of the present application.

Based on the embodiment shown in FIG. 3, step S22, correcting the lamp bead based on the calculation result and the initial brightness level of at least one lamp bead to obtain the corrected brightness level, includes the following steps.

Step S221, when the calculation result is greater than a first calculation result threshold and less than or equal to a second calculation result threshold, correcting the lamp bead according to the initial brightness level of the lamp bead.

For example, assuming there are a total of 1712 lamp beads on the lamp panel, the first calculation result threshold is set to 1080, and the second calculation result threshold is set to 1200.

When the calculation result is greater than 1080 and less than or equal to 1200, the number of lamp beads lit on the lamp panel is greater than 1080 and less than 1200.

Step S222, if the initial brightness level of the lamp bead is greater than or equal to the third brightness level threshold, decreasing the lamp bead by one brightness level to obtain the corrected brightness level.

For example, the first brightness level threshold is set to 5, the second brightness level threshold to 6, the third brightness level threshold to 10, the fourth brightness level threshold to 13, and the fifth brightness level threshold to 14.

When the calculation result is greater than the first calculation result threshold and less than or equal to the second calculation result threshold, if the initial brightness level of the lamp bead is 15, which is greater than the third brightness level threshold of 10, the brightness level of the lamp bead is reduced to 14.

In an embodiment, when the calculation result is less than the first calculation result threshold, the brightness level of the lamp bead remains unchanged.

The embodiment of the present application corrects the lamp bead based on the calculation results and the initial brightness level of at least one lamp bead to obtain the corrected brightness level. Based on the corrected brightness level, the power level of each frame of the image is determined, thereby controlling the power of the image to be displayed, reducing energy loss of the lamp panel, and thus extending the lifespan of the lamp panel.

Referring to FIG. 5, FIG. 5 is a flow chart illustrating the method for processing display data according to another exemplary embodiment of the present application.

Based on the embodiment shown in FIG. 3, step S22, correcting the lamp bead based on the calculation result and the initial brightness level of at least one lamp bead to obtain the corrected brightness level, further includes the following steps.

Step S223, when the calculation result is greater than the second calculation result threshold and less than or equal to the third calculation result threshold, correcting the lamp bead according to the initial brightness level of the lamp bead.

For example, assuming the total number of lamp beads on the lamp panel is 1712, the second calculation result threshold is set to 1200, and the third calculation result threshold is set to 1320.

Specifically, when the calculation result is greater than 1200 and less than or equal to 1320, the number of lamp beads lit on the lamp panel is greater than 1200 but less than 1320.

Step S224, if the initial brightness level of the lamp bead is greater than or equal to the fourth brightness level threshold, decreasing the lamp bead by two brightness levels to obtain the corrected brightness level.

For example, the fourth brightness level threshold, as described in the previous embodiment, is 13.

Specifically, when the calculation result is greater than the second calculation result threshold and less than or equal to the third calculation result threshold, if the initial brightness level of the lamp bead is 15 and greater than or equal to the fourth brightness level threshold of 13, the brightness level of the lamp bead is reduced to 13.

Step S225, if the initial brightness level of the lamp bead is greater than or equal to the second brightness level threshold and less than the fourth brightness level threshold, decreasing the lamp bead by one brightness level to obtain the corrected brightness level.

For example, the second brightness level threshold, as described in the previous embodiment, is 6.

When the calculation result is greater than the second calculation result threshold and less than or equal to the third calculation result threshold, if the initial brightness level of the lamp bead is 12, which is greater than the second brightness level threshold of 6 and less than the fourth brightness level threshold of 13, the brightness level of the lamp bead is reduced to 11.

This embodiment of the present application corrects the lamp bead based on the calculation result and the initial brightness level of at least one lamp bead to obtain the corrected brightness level. Based on the corrected brightness level, the power level of each frame of the image is determined, thereby controlling the power of the image to be displayed, reducing energy loss of the lamp panel, and thus extending the lifespan of the lamp panel.

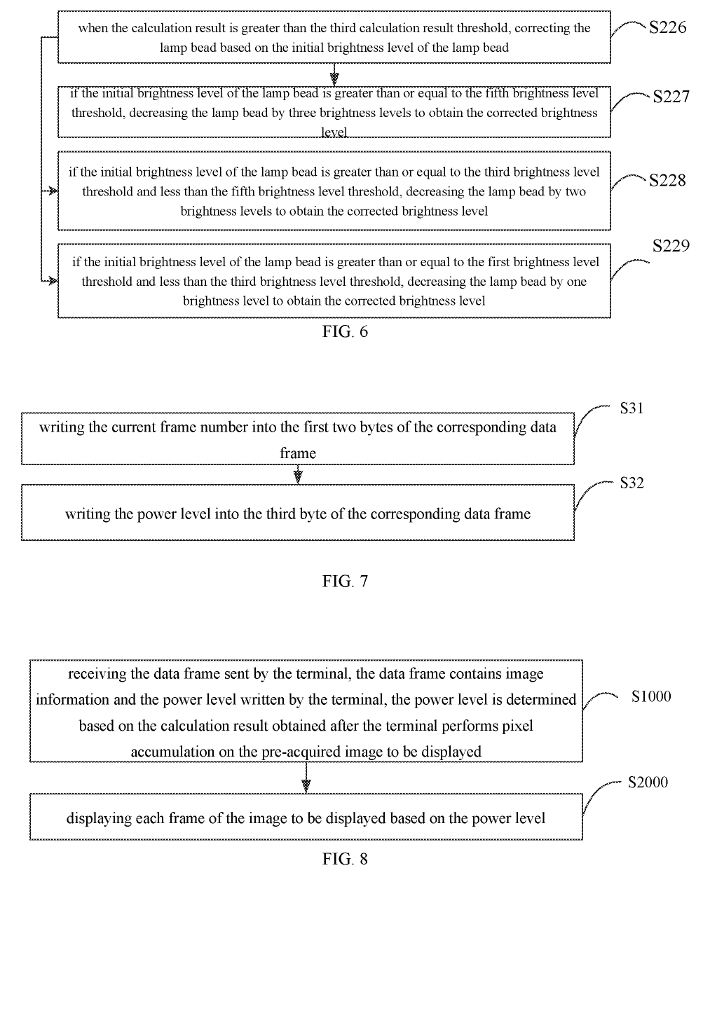

Referring to FIG. 6, FIG. 6 is a flow chart illustrating the method for processing display data according to another exemplary embodiment of the present application.

Based on the embodiment shown in FIG. 3, step S22, correcting the lamp bead based on the calculation result and the initial brightness level of at least one lamp bead to obtain the corrected brightness level, further includes the following steps.

Step S226, when the calculation result is greater than the third calculation result threshold, correcting the lamp bead based on the initial brightness level of the lamp bead.

For example, assuming the total number of lamp beads on the lamp panel is 1712, and the third calculation result threshold is 1320.

When the calculation result is greater than 1320, the number of lamp beads lit on the lamp panel is greater than 1320.

Step S227, if the initial brightness level of the lamp bead is greater than or equal to the fifth brightness level threshold, decreasing the lamp bead by three brightness levels to obtain the corrected brightness level.

For example, the fifth brightness level threshold, as described in the embodiment of FIG. 4, is 14.

Specifically, when the calculation result is greater than the third calculation result threshold, if the initial brightness level of the lamp bead is 15, which is greater than the fifth brightness level threshold of 14, the brightness level of the lamp bead is reduced to 12.

Step S228, if the initial brightness level of the lamp bead is greater than or equal to the third brightness level threshold and less than the fifth brightness level threshold, decreasing the lamp bead by two brightness levels to obtain the corrected brightness level.

For example, the third brightness level threshold, as described in the embodiment of FIG. 4, is 10.

When the calculation result is greater than the third calculation result threshold, if the initial brightness level of the lamp bead is 13, which is greater than the third brightness level threshold of 10 and less than the fifth brightness level threshold of 14, the brightness level of the lamp bead is reduced to 11.

Step S229, if the initial brightness level of the lamp bead is greater than or equal to the first brightness level threshold and less than the third brightness level threshold, decreasing the lamp bead by one brightness level to obtain the corrected brightness level.

For example, the third brightness level threshold, as described in the embodiment of FIG. 4, is 5.

When the calculation result is greater than the third calculation result threshold, if the initial brightness level of the lamp bead is 9, which is greater than the first brightness level threshold of 5 and less than the third brightness level threshold of 10, the brightness level of the lamp bead is reduced to 8.

This embodiment of the present application corrects the lamp bead based on the calculation result and the initial brightness level of at least one lamp bead to obtain the corrected brightness level. Based on the corrected brightness level, the power level of each frame of the image is determined, thereby controlling the power of the image to be displayed, reducing energy loss of the lamp panel, and thus extending the lifespan of the lamp panel.

Referring to FIG. 7, FIG. 7 is a flow chart illustrating the method for processing display data according to another exemplary embodiment of the present application.

Based on the embodiment shown in FIG. 3, step S30, writing the image information and the power level of each frame into the corresponding data frame, includes:

step S31, writing the current frame number into the first two bytes of the corresponding data frame.

The embodiments of the present application improve the structure of the data frame.

For example, each frame of data contains 964 bytes, where the first two bytes represent the current frame number, with a maximum value of 65535, which can cover all the images used.

Step S32, writing the power level into the third byte of the corresponding data frame.

The third byte of the data frame serves as the power level, with a value ranging from 0x01 to 0x0F.

This embodiment of the present application improves the structure of the data frame, enabling it to transmit the corresponding image power level to the lamp panel. This allows for control of the power of the image to be displayed, reducing energy loss from the lamp panel and extending its lifespan.

Referring to FIG. 8, FIG. 8 is a flow chart illustrating the method for processing display data according to another exemplary embodiment of the present application.

Based on the embodiment shown in FIG. 3, the method is applied to a lamp panel. The method for processing display data includes:

Step S1000, receiving the data frame sent by the terminal, the data frame contains image information and the power level written by the terminal, the power level is determined based on the calculation result obtained after the terminal performs pixel accumulation on the pre-acquired image to be displayed.

The lamp panel includes a data processing unit and a front-row lamp panel.

After receiving the data frame from the terminal, the data processing unit in the lamp panel extracts the image information and the power level.

Then, each frame of the image to be displayed is displayed based on the power level.

Step S2000, displaying each frame of the image to be displayed based on the power level.

The image information may include: image size, current frame number, image type, etc.

Taking the current frame number as an example, a frame of the image to be displayed is determined based on the current frame number in the frame data, and the power level in the data frame is associated with that frame of the image.

Then, the lamp panel displays the image in the data frame based on the power level in the data frame.

This embodiment of the present application receives the data frame sent by the terminal and then displays each frame of the image to be displayed based on the power level in the data frame. This allows for control of the power of the image to be displayed, reducing energy loss of the lamp panel and thus extending its lifespan.

Furthermore, the present application also proposes an apparatus for processing display data, provided at a control terminal. The apparatus for processing display data includes: a data calculation module, a data preparation module, a data frame writing module and an interaction module.

The data calculation module is configured to perform pixel accumulation on a pre-acquired image to be displayed to obtain the calculation result.

The data preparation module is configured to determine the power level of each frame of the image to be displayed based on the calculation result.

The data frame writing module is configured to write the image information and the power level of each frame of the image into the corresponding data frame.

The interaction module is configured to send the data frame to the lamp panel, so that the lamp panel can display each frame of the image to be displayed based on the power level and the image information.

The principle and implementation process of display data processing in this embodiment can refer to at least one of the above embodiments and will not be repeated here.

Furthermore, the present application also proposes a terminal device, and the terminal device includes a memory, a processor, and a program for processing display data stored in the memory and executable on the processor. The program for processing display data, when executed by the processor, implements the steps of the method for processing display data described above.

Since this program for processing display data employs all the technical solutions of all the foregoing embodiments when executed by the processor, it possesses at least all the beneficial effects brought about by all the technical solutions of all the foregoing embodiments, which will not be repeated here.

Furthermore, the present application also proposes a computer-readable storage medium on which the program for processing display data is stored. The program for processing display data, when executed by the processor, implements the steps of the method for processing display data described above.

Since this program for processing display data employs all the technical solutions of all the foregoing embodiments when executed by the processor, it has at least all the beneficial effects brought about by all the technical solutions of all the foregoing embodiments, which will not be repeated here.

This embodiment, through the above solution, specifically performs pixel accumulation on the pre-acquired image to be displayed to obtain the calculation result; determines the power level of each frame of the image to be displayed based on the calculation result; writes the image information and the power level of each frame into the corresponding data frame; and sends the data frame to the lamp panel so that the lamp panel can display each frame of the image to be displayed based on the power level and the image information. The embodiment of the present application performs pixel accumulation on the pre-acquired image to be displayed to obtain the calculation result, determines an appropriate power level based on the calculation result, and sends the power level to the lamp panel through the data frame. Thus, based on the corresponding power level, the lamp panel can be controlled to display each frame of the image to be displayed, thereby reducing the energy loss of the lamp panel and extending its service life.

It should be noted that, in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a...” does not exclude the existence of other identical elements in the process, method, article or system that includes the element.

The sequence numbers of the embodiments in the present application are for descriptive purposes only and do not represent the superiority or inferiority of the embodiments.

Through the description of the above embodiments, those skilled in the art can clearly understand that the methods of the above embodiments can be implemented by means of software plus a necessary general-purpose hardware platform, and of course also by hardware, but in many cases the former is better implementation. Based on this understanding, the essence of the technical solution of the present application or the part that contributes to the prior art can be embodied in the form of software products, the computer software product is stored in one storage medium (such as ROM/RAM, magnetic disk, optical disk), including several instructions to make a terminal device (which may be a mobile phone, a computer, a server, a controlled terminal, or a network device, etc.) execute the method of each embodiment of the present application.

The above are only some embodiments of the present application, and are not therefore limiting the scope of the present application. Any equivalent structure or equivalent process transformation made by using the contents of the specification and drawings of the present application, or directly or indirectly used in other related technical fields, is also included in the scope of the present application.

What is claimed is:

1. A method for processing display data, applied to a control terminal, the method comprising:
performing pixel accumulation on a pre-acquired image to be displayed to obtain a calculation result;
determining a power level of each frame of the image to be displayed based on the calculation result;
writing image information and the power level of each frame into a corresponding data frame; and
sending the data frame to a lamp panel, so that the lamp panel displays each frame of the image to be displayed based on the power level and the image information.

2. The method according to claim 1, wherein the determining the power level of each frame of the image to be displayed based on the calculation result comprises:
calculating an initial brightness level of at least one lamp bead in response to that the lamp panel displays each frame of the image;
correcting the at least one lamp bead based on the calculation result and the initial brightness level of the at least one lamp bead to obtain a corrected brightness level; and
determining the power level of each frame of the image based on the corrected brightness level.

3. The method according to claim 2, wherein the correcting the at least one lamp bead based on the calculation result and the initial brightness level of the at least one lamp bead to obtain the corrected brightness level comprises:
in response to that the calculation result is greater than a first calculation result threshold and less than or equal to a second calculation result threshold, correcting the at least one lamp bead according to the initial brightness level of the at least one lamp bead; and
in response to that the initial brightness level of the at least one lamp bead is greater than or equal to a third brightness level threshold, decreasing the at least one lamp bead by one brightness level to obtain the corrected brightness level.

4. The method according to claim 2, wherein the correcting the at least one lamp bead based on the calculation result and the initial brightness level of the at least one lamp bead to obtain the corrected brightness level further comprises:
in response to that the calculation result is greater than a second calculation result threshold and less than or equal to a third calculation result threshold, correcting the at least one lamp bead according to the initial brightness level of the at least one lamp bead;
in response to that the initial brightness level of the at least one lamp bead is greater than or equal to a fourth brightness level threshold, decreasing the at least one lamp bead by two brightness levels to obtain the corrected brightness level; and
in response to that the initial brightness level of the at least one lamp bead is greater than or equal to a second brightness level threshold and less than the fourth brightness level threshold, decreasing the at least one lamp bead by one brightness level to obtain the corrected brightness level.

5. The method according to claim 2, wherein the correcting the at least one lamp bead based on the calculation result and the initial brightness level of the at least one lamp bead to obtain the corrected brightness level further comprises:
in response to that the calculation result is greater than a third calculation result threshold, correcting the at least one lamp bead according to the initial brightness level of the at least one lamp bead;
in response to that the initial brightness level of the at least one lamp bead is greater than or equal to a fifth brightness level threshold, decreasing the at least one lamp bead by three brightness levels to obtain the corrected brightness level;
in response to that the initial brightness level of the at least one lamp bead is greater than or equal to a third brightness level threshold and less than the fifth brightness level threshold, decreasing the at least one lamp bead by two brightness levels to obtain the corrected brightness level; and
in response to that the initial brightness level of the at least one lamp bead is greater than or equal to a first brightness level threshold and less than a third brightness level threshold, decreasing the at least one lamp bead by one brightness level to obtain the corrected brightness level.

6. The method according to claim 1, wherein the writing the image information and the power level of each frame into the corresponding data frame comprises:
writing a current frame number into first two bytes of the corresponding data frame; and
writing the power level into a third byte of the corresponding data frame.

7. A method for processing display data, applied to a lamp panel, the method comprising:
receiving a data frame sent by a terminal, wherein the data frame contains image information and a power level written by the terminal, and the power level is determined based on the calculation result obtained by the terminal after performing pixel accumulation on a pre-acquired image to be displayed; and
displaying each frame of the image to be displayed based on the power level.

8. An apparatus for processing display data, provided at a control terminal, the apparatus comprising:
a data calculation module configured to perform pixel accumulation on a pre-acquired image to be displayed to obtain a calculation result;
a data preparation module configured to determine a power level of each frame of the image to be displayed based on the calculation result;
a data frame writing module configured to write image information and the power level of each frame of the image into a corresponding data frame; and
an interaction module configured to send the data frame to a lamp panel, so that the lamp panel displays each frame of the image to be displayed based on the power level and the image information.

9. A terminal device for processing display data, comprising:
a memory;
a processor; and
a computer program stored in the memory and executable on the processor, wherein the computer program, when executed by the processor, performs the following method:
performing pixel accumulation on a pre-acquired image to be displayed to obtain a calculation result;
determining a power level of each frame of the image to be displayed based on the calculation result;
writing image information and the power level of each frame into a corresponding data frame; and
sending the data frame to a lamp panel so that the lamp panel displays each frame of the image to be displayed based on the power level and the image information.

10. The terminal device according to claim 9, wherein the computer program, when executed by the processor, further implements the following steps:
calculating an initial brightness level of at least one lamp bead when the lamp panel displays each frame;
correcting the at least one lamp bead based on the calculation result and the initial brightness level of the at least one lamp bead to obtain a corrected brightness level; and
determining the power level of each frame based on the corrected brightness level.

11. The terminal device according to claim 10, wherein the computer program, when executed by the processor, further implements the following steps:
in response to that the calculation result is greater than a first calculation result threshold and less than or equal to a second calculation result threshold, correcting the at least one lamp bead according to the initial brightness level of the at least one lamp bead; and
in response to that the initial brightness level of the at least one lamp bead is greater than or equal to a third brightness level threshold, decreasing the at least one lamp bead by one brightness level to obtain the corrected brightness level.

12. The terminal device according to claim 10, wherein the computer program, when executed by the processor, further implements the following steps:
in response to that the calculation result is greater than a second calculation result threshold and less than or equal to a third calculation result threshold, correcting the at least one lamp bead according to the initial brightness level of the at least one lamp bead;
in response to that the initial brightness level of the at least one lamp bead is greater than or equal to a fourth brightness level threshold, decreasing the at least one lamp bead by two brightness levels to obtain the corrected brightness level; and
in response to that the initial brightness level of the at least one lamp bead is greater than or equal to a second brightness level threshold and less than a fourth brightness level threshold, decreasing the at least one lamp bead by one brightness level to obtain the corrected brightness level.

13. The terminal device according to claim 10, wherein the computer program, when executed by the processor, further implements the following steps:
in response to that the calculation result is greater than a third calculation result threshold, correcting the at least one lamp bead according to the initial brightness level of the at least one lamp bead;
in response to that the initial brightness level of the at least one lamp bead is greater than or equal to a fifth brightness level threshold, decreasing the at least one lamp bead by three brightness levels to obtain the corrected brightness level;
in response to that the initial brightness level of the at least one lamp bead is greater than or equal to a third brightness level threshold and less than a fifth brightness level threshold, decreasing the at least one lamp bead by two brightness levels to obtain the corrected brightness level; and
in response to that the initial brightness level of the at least one lamp bead is greater than or equal to a first brightness level threshold and less than a third brightness level threshold, decreasing the at least one lamp bead by one brightness level to obtain the corrected brightness level.

14. The terminal device according to claim 9, wherein the computer program, when executed by the processor, further implements the following steps:
writing a current frame number into first two bytes of the corresponding data frame; and
writing the power level into a third byte of the corresponding data frame.

15. A non-transitory computer-readable storage medium, wherein a computer program is stored on the non-transitory computer-readable storage medium, and the computer program, when executed by a processor, implements the method for processing display data according to claim 1.
